(19) United States
(12) Patent Application Publication
(10) Pub. No.: US 2013/0188960 A1
(43) Pub. Date: Jul. 25, 2013

(54) One-Handed Remote Unit That Can Control Multiple Devices

(71) Applicants: Xiuzhi Gao, Mount Prospect, IL (US); Joseph Born, Lincolnwood, IL (US)

(72) Inventors: Xiuzhi Gao, Mount Prospect, IL (US); Joseph Born, Lincolnwood, IL (US)

(21) Appl. No.: 13/557,422

(22) Filed: Jul. 25, 2012

Related U.S. Application Data
(60) Provisional application No. 61/511,417, filed on Jul. 25, 2011.

(51) Int. Cl. G08C 23/04

(52) U.S. Cl. CPC G08C 23/04
USPC 398/106

(57) ABSTRACT

A universal console using infra-red (IR) technology allows users to consolidate their remote control devices to a single universal device that can control a PC, DVD, games, TV, and other IR coupled devices. It further has the benefit of being highly power efficient and thus allowing the use of batteries without needed to be recharged or replaced for many months. Through the use of different dongles (and different configurations) different models can be offered for use on game consoles, smart TVs, and other connected devices.

This application is related to and claims priority from U.S. Provisional Patent Application No. 61/511,417 filed Jul. 25, 2011. Application 61/511,417 is hereby incorporated by reference.

### BACKGROUND

1. Field of the Invention

The present invention relates generally to handheld devices and more particularly to a one handed device that can control both a TV and the computer.

2. Description of the Prior Art

Internet television is emerging as a mainstream activity in the US. Some major Internet TV sites have over 50 million viewers today. In some cases, it is an alternative to traditional paid cable TV. Over the next few years, it is likely that the market will continue to be fragmented with a host of competing, proprietary solutions and consumers will sit on the sidelines waiting to make a new device investment.

At the same time, PC software continues to develop that makes the PC a more compelling solution for couch use, with a variety of applications that have been developed for use from the couch, and with a remote. In addition, a new breed of “TV” computers, often selling for as little as $200 has emerged from a variety of manufacturers from Acer to Dell and many others that allow a connection to the TV set. It is entirely possible that these small, quiet, inexpensive computers, populated with dedicated TV browsing software will be the device of choice for consumers. Another candidate often mentioned is the game console, including the Nintendo Wii™, Xbox™ 360, and Sony PS3 and many others. Finally, it is also possible that other kinds of “set-top” boxes (either those dedicated to displaying content from the Internet or those from traditional cable or satellite operators) will evolve to include more traditional computer type web browsers.

There is a clear need for an inexpensive, one handed device that can control both the TV and the computer (or the TV and the game console). While a variety of manufacturers have begun to introduce small, handheld, 2.4 GHz or bluetooth keyboards/mice they have been expensive and do not have universal remote functionality. That is, while they can control the PC, they cannot control the TV set or other peripherals. At the same time, other devices have allowed control via smartphone or tablets. Such devices are generally too expensive to be dedicated as controllers and thus, there remains a need for a dedicated universal controller that will remain proximate to the display screen and available to all users in the home.

### SUMMARY OF THE INVENTION

The present invention using infra-red (IR) technology, yields a solution that can sell at prices approaching that of a conventional IR universal remote and also allow users to consolidate their remote control devices to a single universal device. It further has the benefit of being highly power efficient and thus allowing the use of batteries without needed to be recharged or replaced for many months. Through the use of different dongles (and different configurations) different models can be offered for use on the game consoles such as Nintendo Wii, Xbox 360, etc. and ultimately smart TVs, and other connected devices.

Universal, programmable remotes in a variety of shapes and sizes are well known in the industry as well as wireless keyboards and remotes for use with personal computers. To date, no solution is known for a device that combines the functionality for controlling personal computers and other connected devices, such as game consoles, the Roku type Internet based streaming devices, and others. In addition to all the devices previously controlled by programmable universal remote controls, such as televisions and dvd players, etc.

The challenges to providing a truly universal remote solution that affords control of all the potential devices are myriad. They include incompatible wireless interfaces, including Infra red and RF technologies (in varying forms and frequencies) as well as incompatible data input mechanisms. For example, some devices do not allow direct input of alphanumeric characters from the remote control, but instead expect the user (via remote control) to input such characters via on screen virtual keyboards. In other cases, the devices can accept only incomplete sets of instructions via a given input technology such as allowing control of a device via a dongle connected to an input jack on the device, but omitting the ability to power the device on from such an input jack.

The present invention solves these issues by combining a unique remote and a system of dongles which are designed specifically for the idiosyncrasies of individual devices as needed.

### DESCRIPTION OF THE FIGURES

Attention is now directed to several drawings that illustrate features of the present invention:

FIG. 1 shows an embodiment of a hand-held unit according to the present invention.

FIG. 2 shows a diagram of the hand-held unit controlling different devices, some of the devices using unique dongles.

FIGS. 3A-3B shows a view of the geometry of the rubber buttons and contacts.

FIGS. 4A-4B shows a pointing stick multi-contact press that can be used with the hand-held unit.

FIG. 5 shows a dongle with a relay to control power.

Several drawings and illustrations have been presented to aid in understanding the present invention. The scope of the present invention is not limited to what is shown in the figures.

### DESCRIPTION OF A PREFERRED EMBODIMENT

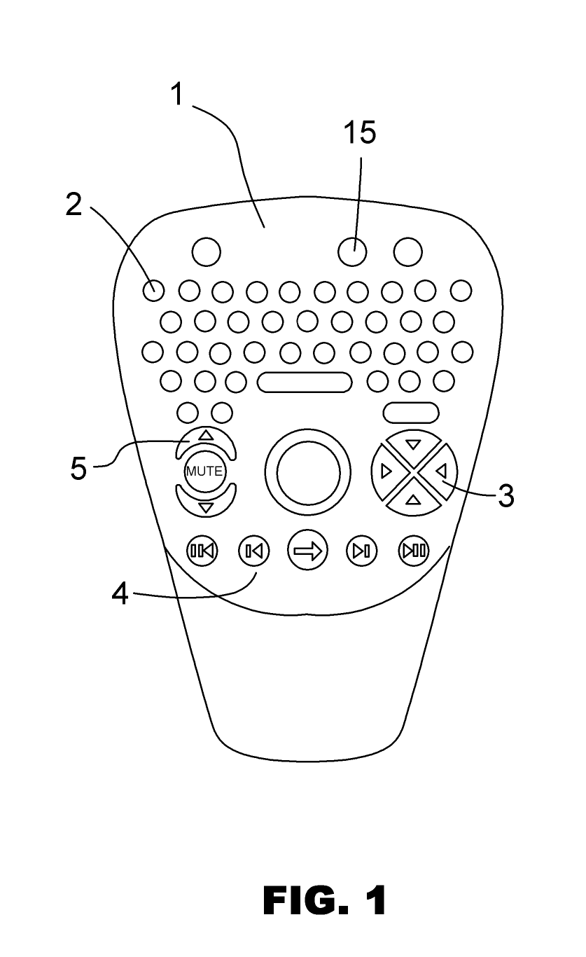

The present invention using infra-red (IR) technology, yields a solution that can sell at prices approaching that of a conventional IR universal remote and also allow users to consolidate their remote control devices to a single universal device. FIG. 1 shows an embodiment of such a device. A console 1 contains a plurality of buttons 2 that allow entry of letters and numbers. The housing 1 also contains different types of joy stick or navigational buttons 3, 5, and buttons to control presentation of video or audio 4.

In an embodiment of the present invention, the keyboard part 2 of the remote can perform all the functions of a PC keyboard. In some cases, function keys 15 can be employed to provide additional functions to individual keys thereby reducing the number of physical keys needed. In this embodiment the remote is intended to control a PC for Internet surfing, video and the like, and to provide basic controls to the television 5. In other embodiments, additional devices could be added with separate buttons provided to designate which device was being controls such as TV, DVD player, cable box, and the like.

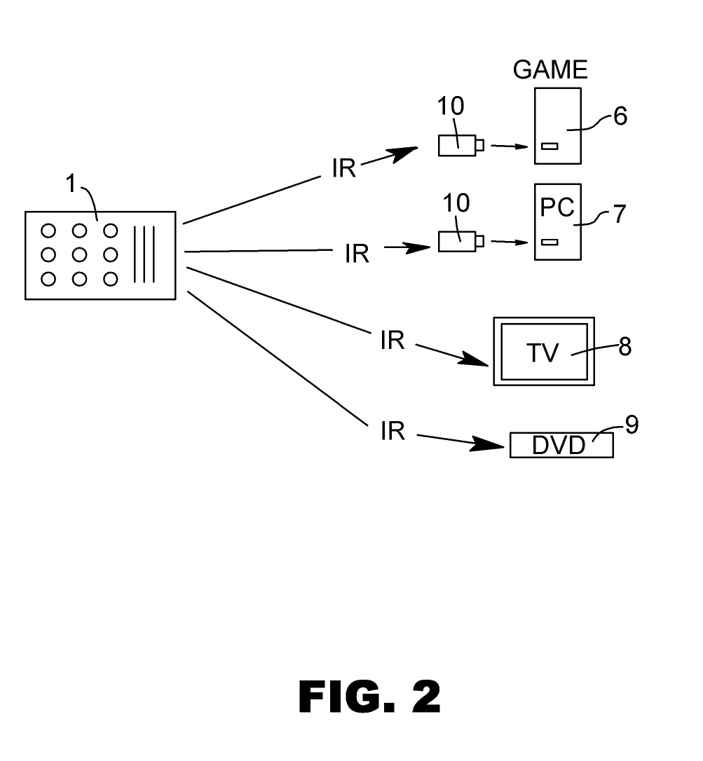

Through the use of different dongles (and different configurations) different models of the invention can be offered for use on the game consoles such as Nintendo Wii™, Xbox 360™, etc. and ultimately smart TVs and other connected devices. FIG. 2 shows a schematic diagram of the hand-held unit of the present invention using IR to control different devices. Some of the devices need unique dongles to be controlled. The console 1 uses IR to control a TV 8, a DVD or other disk video device 9, and to communicate with dongles 10 that can be plugged into the USB port of a PC 7 or a game 6.

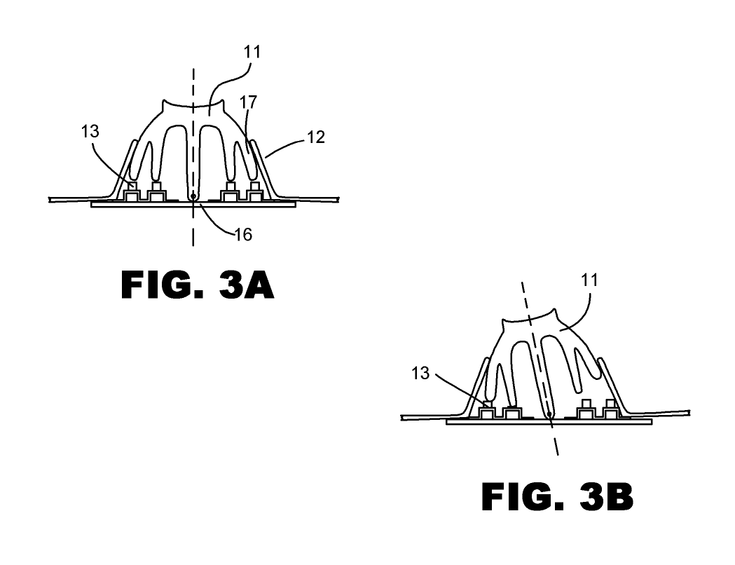

FIGS. 3A-3B show a view of the geometry of the rubber buttons and contacts. As shown, the mouse button has a plastic cap 11 with a top spherical surface held between the circuit board and/or bottom housing 16 and the top housing 12. It is enabled to pivot about a single point (along two axes parallel to the circuit board). As shown the mouse button pivots about a pivot point and is held in place by a top cover and PCB. By designing the circular ribs 17 on the bottom of the mouse button with the appropriate lengths, contact with the rubber buttons 13 can be designed such that the greater the amount of force applied to tilting the mouse button and thus the greater the degree of actuation of the mouse button, the more of the rubber buttons will be actuated as shown in FIG. 3B. The length of the ribs and height of the buttons can be adjusted to provide a proper feel and actuation mechanism.

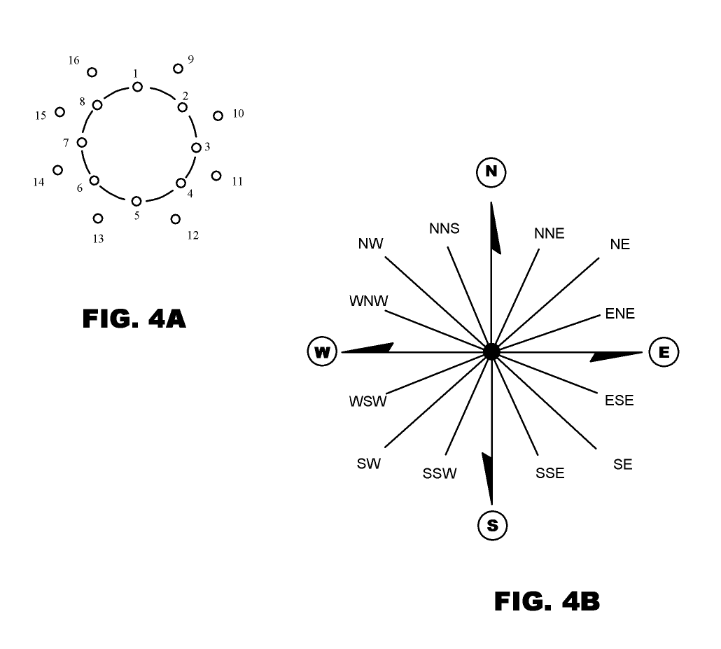

FIGS. 4A-4B show a pointing stick multi-contact press that can be used with the hand-held unit. The algorithm below creates a vector with magnitude dictated by the number of rubber buttons actuated and direction dictated by the average of the angles of the actuated buttons. Other algorithms could potentially be used to create a similar effect. The below was designed to be used on a low cost microcontroller such as would typically be available in a low cost universal remote control.

1> regardless of what buttons are pressed and how many of them are pressed down, mouse should *ALWAYS* respond
2> each button is assigned with the following angle,

| | |
|---|---|
| button 1 --> 0 | 9 --> 22.5 |
| button 2 --> 45 | 10 --> 67.5 |
| button 3 --> 90 | 11 --> 112.5 |
| button 4 --> 135 | 12 --> 157.5 |
| button 5 --> 180 | 13 --> 202.5 |
| button 6 --> 225 | 14 --> 247.5 |
| button 7 --> 270 | 15 --> 292.5 |
| button 8 --> 315 | 16 --> 337.5 |

3>. mouse direction X, Y for any given ‘m’ number of buttons is computed using the following formula,

X=S(m)*C*(cos(A0)+cos(A1)+cos(Am))/m

Y=S(m)*C*(sin(A0)+sin(A1)+sin(Am))/m

where S is a function to determine the speed factor based on number of buttons pressed, Ai is the angle for the button pressed. and C is a constant to give us integer table math. In programming, C*sin(Ai) and C*cos(Ai) can be put into a lookup table.
This way, there's no special case, and any number of buttons can be supported.

It should be appreciated that other algorithms can be used to translate a given number of actuated buttons into direction and velocity instructions for a cursor's movement. It should also be appreciated that alternative means of cursor control could be employed such as a touchpad, trackball or using motion control such as accelerometers and gyroscopes.

### Macros for the Alphabet Keys

Macros have long been used in remote controls and keyboards to streamline routine tasks performed by users and allow a single button press to initiate a sequence of commands that comprise a commonly repeated task.

In the present invention, a series of simulated button presses can be initiated translate the press of an alphabet key on the remote into the necessary navigation actions required to enter that character on the on screen's virtual keyboard. In other words, rather than having to navigate to a given letter from an on screen keyboard with a series of arrow strokes, the user could simply press the “A” key and the remote would initiate the navigation sequence for them.

### Dongles

### PC Dongle

Since most PCs do not have IR receivers to receive signals from the remote control, some sort of interface is needed—this can be a dongle. Some PCs that do have IR recievers have standards that are not compatible with the IR signals from remote controls, instead using the IRDA standard employed by some PDA. Further, even those PCs that do have consumer IR receivers that can be used with typical remotes may not support the keyboard and mouse input. Thus, the invention can include a USB dongle that can receive IR signals from the remote and translate these into keyboard, mouse and media control signals (play/pause/rewind, etc). Such dongles provide plug and play installation for users and are well established in the support of wireless keyboards (typically operating on RF wireless bands). While IR is the preferred mode of communication, any other wireless technique including wireless radio frequencies RF is within the scope of the present invention.

### Dongle Including Power Control

In some cases where a dongle provides incomplete access to the functionality of the host device, it may be necessary to augment the ability of the dongle to provide control functions. One important omission that is sometimes found is the ability to power on, or wake from a sleep or suspend state. In these cases, one option is that the dongle is connected to the device power source and can initiate power to the device via a relay. This option is useful for those devices whose default state is on when power is connected to them.

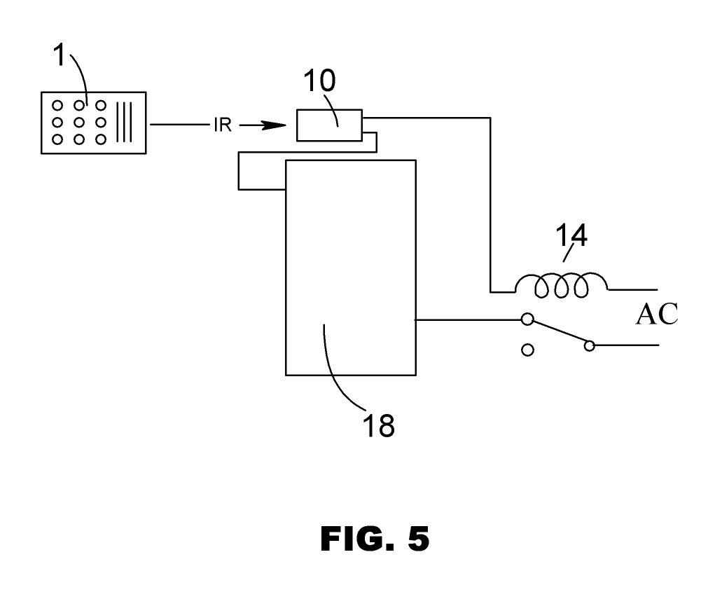

FIG. 5 shows a dongle with a relay to control power. The console 1 sends IR to the dongle 10 which controls a relay 14 that turns power on and off to a device 18.
Dongle with Wireless

In addition to a physical connection to a host device, there are cases where a wireless connection could be of benefit. As an example, it is sometimes the case that a wireless connection, such as bluetooth can provide additional control functionality to a host device. In these cases, the physical connection could simply be used for power. Such power would be available to power the dongle when the host device was on and delivering power to the dongle. In addition, it could also be used to charge a dongle internal battery, allowing the dongle to operate even in situations where the host device was not providing power to the dongle. One use for this would be to allow the dongle to turn the host device on. It should be appreciated that in cases where the host device is not available for power, there are a variety of alternatives available including a separate connection to a household power outlet.

### Dongle Wireless Control Through Host Device

As an alternative to the dongle itself containing wireless hardware, it could also be possible through the use of software residing on the host machine that wireless signals initiated by the remote could be transmitted wirelessly to other devices. For example, in the case where the host device is a PC, a remote control keypress (or combination of keypresses) could be used to initiate action on the PC which controls another device on the network through the PC's onboard wifi connection. The PC would be able to log into another local (or even remote) device through, for example, a web connection, and initiate action. Many media players allow control of the devices via a web or other network connection that are made available for use by desktop, laptop or handheld computing devices, including tablets and mobile phones. Such a control scheme would allow for the control of device which are not available to the remote via line of sight controls or for which no IR receiver is available.

### Switching Between Host Devices

As mentioned previously, multiple devices could be controlled with the remote. In some cases, including the one pictured in the keyboard pictured above, the target device can be distinguished by individual key press. For example, because the pictured device configuration can only control two devices with each of these having different functions, keys can remain dedicated in their functions to a single device. For example, mouse, keyboard and media key buttons can be dedicated to the PC since it would not be expected that such keys would have any function on the TV itself. Likewise, volume can be dedicated to the TV since it can be presumed that volume control would be more frequently desired on the TV than on the PC.

In cases where multiple devices requiring the same controls would be employed, such as the case of a Blu Ray™ player and a PC where both could use the play/pause and other media control buttons a series of device buttons would be used that would allow the user to specify the target device. In some cases, such a target specification would be programmable by the user to modify the output of the remote's IR signal such that it could be accepted by a device that accepts such a signal. This is the method typically employed by IR universal programmable remotes and methods for programming such devices is well known, including choosing from an internal database of known devices to methods for learning the codes of unknown devices by various means.

In other cases, dongles, either bundled with the remote, or purchased and installed separately, would be employed. In these cases, targeting these devices would typically be enabled by switching the IR protocol to a known configuration for these dongles. The dongles would then provide a known protocol to the host device and emulate the control signals accepted by the host device.

In still other cases, as described above, the target device could be controlled via a host device acting through the home network for example, such as with a PC controlling a media player via an available web interface. In those cases, the immediate target of the remote control would be the device hosting the dongle, and a special signal would be sent to that dongle which would designate that the action be delivered to the ultimate target device. It should be appreciated that a variety of schemes could be used to initiate such communication and distinguish it from actions intended to be taken directly on the host device. As one example, an unused keyboard shortcut such as cntrl+play/pause could be sent to a host PC if the remote's target action was play/pause to be taken on the web accessed media player. In this way, the PC would not interpret this action as an instruction to direct a play/pause button press to its internal media playing program.

Feedback from the IR Dongle to the Remote

An additional embodiment of the invention puts IR emitters on some or all of the device dongles, and an IR receiver on the remote control. Such a configuration would allow feedback from the host devices to the remote control. A stream of communication feeding back to the remote could provide myriad new functions. It should be appreciated that IR communication back to the remote is only one possible means of communicating back to the remote, which could alternatively be RF wireless or even audible sound (using a microphone on the remote)

### Updating the Remote

If the host device were provided with a mechanism for communicating back to the remote, it could update the remote with new codes and macros for operation. As new devices were introduced to the market or as new functions were developed by the manufacturer, or 3^{rd} parties if the system were designed to accept such 3^{rd} party contributions. Since many host devices are themselves anticipated to be connected to remote servers through the Internet (or other networks) this would allow remote access to the remote control thus allowing it to be stay updated as changes in technology or other host devices dictate that updates would be useful.

### Notifications

A feedback stream to the remote would allow it to present notifications to the user. Such notifications could take a variety of forms. Users could be alerted to the availability of new shows, of messages from friends or reviewers or editors, etc. Notifications from social networks are well known and could be presented in a variety of forms such as by illuminating an LED or the like.

### Feedback of State Information to Remote

The ability to provide feedback from the host machine to the remote could allow the remote to provide contextual feedback to the user. In the simplest example, the remote could illuminate the appropriate buttons for the current state of the host machine. For example, if media is currently playing, then only the pause symbol could be illuminated, as the play action is not appropriate (since media is already playing). Likewise, when media is paused, the play button would be illuminated and the pause would be dark. The use of contextual controls is well known and regularly applied to “soft buttons” in mobile applications as one example. While one embodiment of this invention can illuminate the appropriate “hard” (physical) buttons to provide control guidance to a user, there are many others that could be employed including the use of a small display or the like.

Several descriptions and illustrations have been provided to aid in understanding the present invention. One with skill in the art will realize that numerous changes and variations are possible without departing from the spirit of the invention. Each of these changes and variations is within the scope of the present invention.

1. A remote control that can control multiple devices comprising:
a hand-held remote unit with a plurality of alphanumeric and numeric keys, command keys and a pointing device, said hand-held remote unit being adapted to transmit data to a computer or game commands to a game console using IR or RF;
a first dongle attachable to said computer, the first dongle being adapted to receive said data and communicate it to the computer;
said hand-held remote unit also being adapted to transmit a command to a TV using IR or RF;
said hand-held remote unit also being adapted to transmit a command to a rotating disk video or audio device.

2. The remote control of claim 1 wherein said first dongle can also send update data back to said hand-held remote unit using IR or RF.

3. The remote control of claim 2 wherein said update data contains codes and/or macros for operation.

4. The remote control of claim 1 wherein at least some of said keys are illuminated during use.

5. The remote control of claim 1 wherein said hand-held remote unit receives notifications and updates using IR or RF.

6. The remote control of claim 1 further comprising at least one button that switches between target devices.

7. The remote control of claim 1 further comprising a dongle that receives IR from the hand-held remote unit and communicates wirelessly with the PC or game console.

8. The remote control of claim 1 further comprising a pointing stick multi-contact press which includes a tilting key with at least one rib pressing a plurality of buttons attached to a substrate, wherein more of said buttons are pressed as said key is tilted.

9. The remote control of claim 8 further comprising an algorithm that creates a vector with magnitude determined by a count of actuated buttons and direction determined by an average of angles of the actuated buttons.

10. The remote control of claim 1 wherein an immediate target device of the remote control is a device hosting a dongle, and wherein a signal is sent to that dongle that designates that an action be delivered to an ultimate target device different from the immediate target device.

11. The remote control of claim 4 wherein said hand-held remote unit receives notifications and updates using IR or RF.

12. The remote control of claim 11 further comprising at least one button that switches between target devices.

13. The remote control of claim 12 further comprising a pointing stick multi-contact press which includes a tilting key with a plurality of fingers, each finger pressing a button attached to a substrate, wherein more of said buttons are pressed as said key is tilted.

14. The remote control of claim 13 further comprising an algorithm that creates a vector with magnitude determined by a count of actuated buttons and direction determined by an average of angles of the actuated buttons.

15. A device that can control multiple other devices comprising:
a hand-held remote unit with a plurality of alphanumeric and numeric keys, command keys and a pointing device, said hand-held remote unit being adapted to transmit data to a computer using IR or RF;
a first dongle attachable to said computer, the first dongle being adapted to receive said data and communicate it to the computer;
said hand-held remote unit also being adapted to transmit a command to a TV using IR or RF.

16. The device of claim 15 further comprising a second dongle attachable to the game console, the second dongle being adapted to receive said game commands and communicate them to a game controller.

17. The device of claim 15 wherein said hand-held remote unit is also adapted to transmit a command to a rotating disk video or audio device.

18. The device of claim 15 further comprising at least one button that switches between target devices.

19. A device that can control other devices comprising:
a hand-held remote unit with a plurality of alphanumeric and numeric keys and a pointing device, said hand-held remote unit being adapted to transmit data to a computer or game commands to a game console using IR or RE,
a dongle attachable to the game console, the dongle being adapted to receive said game commands and communicate them to the game;
said hand-held remote unit also being adapted to transmit a command to a TV using IR or RF.

20. A remote control that can control multiple devices comprising:
a hand-held remote unit with a plurality of alphanumeric and numeric keys, commands keys and a pointing device, said hand-held remote unit being adapted to transmit data to a computer or game commands to a game console using IR or RF;
the hand-held remote unit further comprising a pointing stick multi-contact press that includes a tilting key with at least one rib adapted to press a plurality of buttons attached to a substrate, wherein more of said buttons are pressed as said key is tilted.
